(19) United States
(12) Patent Application Publication
(10) Pub. No.: US 2026/0212142 A1
(43) Pub. Date: Jul. 23, 2026

(54) SYSTEMS, METHODS AND DEVICES FOR OBJECT DETECTION USING RADIO FREQUENCY IDENTIFICATION AND ARTIFICIAL INTELLIGENCE

(71) Applicant: MARLEX Engineering Inc., Ancaster (CA)

(72) Inventors: Uwe Dirk Schaible, Ancaster (CA); Jonathan Fava, Ancaster (CA); Steven M. Leatherland, Ancaster (CA); Norman H. von Styp-Rekowski, Ancaster (CA); Gregory E. Mainse, Ancaster (CA)

(21) Appl. No.: 19/458,183

(22) Filed: Jan. 23, 2026

Related U.S. Application Data
(60) Provisional application No. 63/748,731, filed on Jan. 23, 2025.

(51) Int. Cl. G06K 7/10; G06V 10/74; G06V 20/52

(52) U.S. Cl. CPC G06K 7/10297; G06V 10/74; G06V 20/52

(57) ABSTRACT

Systems, methods and devices for object detection are provided. A system includes a radio-frequency identification (RFID) antenna device configured for scanning a target area; generating a dataset based on the scanning, wherein the dataset includes detection information for one or more RFID tags; processing the dataset using an analysis model trained to analyze datasets, the analysis model comprising a machine learning based radial distance model configured to receive the dataset and generate a value describing a radial distance as an output; and providing the output to a user device.

### TECHNICAL FIELD

The following relates generally to safety equipment on machinery, and, in particular to systems, methods and devices for human and asset detection using radio frequency identification and artificial intelligence in machine-to-human and machine-to-asset collision avoidance applications.

### INTRODUCTION

Machinery used in construction, mining, forestry, industrial, aggregate, oil & gas and municipal include heavy-duty vehicles which are able to greatly reduce the time and labour required to carry out large earthwork and material handling operations. As such these machines are generally very large, weighing on the order of several tons.

Therefore, there is an inherent danger when mobile equipment is operating in close proximity to humans and other valuable assets. Many technologies have been developed to mitigate struck-by accidents on job sites.

Such technologies include backup beepers, cameras, radar, or ultrasonic means. However, these techniques are lacking as work sites are generally noisy and busy environments. Machine operators may not be able to monitor audio, video or radar sources at all times in order to react in time. Similarly, other large machinery or assets may be unable to move out of the way of another machine unless moved by personnel.

Accordingly, there is a need for improved systems, methods and devices that overcome at least some of the disadvantages of existing techniques.

This background information is provided to reveal information believed by the applicant to be of possible relevance to the present disclosure. No admission is necessarily intended, nor should be construed, that any of the preceding information constitutes prior art against the present disclosure.

### SUMMARY

A system for object detection is provided. The system includes a radio-frequency identification (RFID) antenna device configured for scanning a target area; generating a dataset based on the scanning, wherein the dataset includes detection information for one or more RFID tags; processing the dataset using an analysis model trained to analyze datasets, the analysis model comprising a machine learning based radial distance model configured to receive the dataset and generate a value describing a radial distance as an output; and providing the output to a user device

In an embodiment, the system further includes an imaging device configured for capturing video data of the target area; and providing the video data to the RFID antenna device.

In an embodiment, the imaging device is further configured for identifying a target in the video data using a detection model trained to detect targets, the detection model comprising a machine learning based target detection model configured to receive the video data and generate a score describing a detection.

In an embodiment, the RFID antenna device is further configured for analyzing the video data using the datasets and an object detection model trained to detect at least one object in the video data indicative of a potential hazard, the object detection model comprising a machine learning based model configured to receive the video data and generate annotated video data as an output.

In an embodiment, the detection information includes at least one of an antenna type, a gain, a polarization, an RFID tag type, an apparel type, an asset type, a number of times a specific RFID tag was detected, an RFID tag detection frequency, a distribution of RFID tags associated with a unique apparel identifier, a distribution of RFID tags associated with a unique asset identifier, a transceiver power level used to detect an RFID tag, and an RSS value measured by a transceiver during RFID tag detection.

In an embodiment, the score is one of a single numerical score; and a categorical score.

In an embodiment, an antenna of the RFID antenna device is located one of internal to RFID antenna device; and external to the RFID antenna device.

In an embodiment, an antenna of the RFID antenna device is at least one of a directional single node antenna with linear polarization and integrated antenna controller; a directional dual node antenna with linear polarization and integrated antenna controller; a planar antenna element with circular polarization; and an omnidirectional vertical whip antenna with vertical polarization.

In an embodiment, the system further includes at least one of an RFID transceiver; and an RFID transponder for communicating data about the at least one object to the RFID antenna device.

In an embodiment, the object detection model is further trained to derive ranging information about the at least one object from the communicated data.

A method of object detection is provided. The method includes executing via a computer system comprising at least one processor: scanning a target area; generating a dataset based on the scanning, wherein the dataset includes detection information for one or more RFID tags; processing the dataset using an analysis model trained to analyze datasets, the analysis model comprising a machine learning based radial distance model configured to receive the dataset and generate a value describing a radial distance as an output; and providing the output to a user device.

In an embodiment, the method further includes capturing video data of the target area.

In an embodiment, capturing the video data further includes identifying a target in the video data using a detection model trained to detect targets, the detection model comprising a machine learning based target detection model configured to receive the video data and generate a score describing a detection.

In an embodiment, the method further includes analyzing the video data using the datasets and an object detection model trained to detect at least one object in the video data indicative of a potential hazard, the object detection model comprising a machine learning based model configured to receive the video data and generate annotated video data as an output.

In an embodiment, the detection information includes at least one of an antenna type, a gain, a polarization, an RFID tag type, an apparel type, an asset type, a number of times a specific RFID tag was detected, an RFID tag detection frequency, a distribution of RFID tags associated with a unique apparel identifier, a distribution of RFID tags associated with a unique asset identifier, a transceiver power level used to detect an RFID tag, and an RSS value measured by a transceiver during RFID tag detection.

In an embodiment, the score is one of a single numerical score; and a categorical score.

In an embodiment, an antenna used for the scanning is located one of internal to an RFID antenna device; and external to an RFID antenna device.

In an embodiment, an antenna used for the scanning is at least one of a direction single node antenna with linear polarization and integrated antenna controller; a directional dual node antenna with linear polarization and integrated antenna controller; a planar antenna element with circular polarization; and an omnidirectional vertical whip antenna with vertical polarization.

In an embodiment, the method further includes communicating data about the at least one object to an RFID antenna device.

In an embodiment, the object detection model is further trained to derive ranging information about the at least one object from the communicated data.

A device for object detection is provided. The device includes a network interface; a processor; and a non-transitory computer readable memory having stored thereon instructions that, when executed by the processor, configure the device for: scanning a target area; generating a dataset based on the scanning, wherein the dataset includes detection information for one or more RFID tags; processing the dataset using an analysis model trained to analyze datasets, the analysis model comprising a machine learning based radial distance model configured to receive the dataset and generate a value describing a radial distance as an output; and providing the output to a user device.

In an embodiment, the device is further configured for receiving video data of the target area.

In an embodiment, capturing the video data further includes identifying a target in the video data using a detection model trained to detect targets, the detection model comprising a machine learning based target detection model configured to receive the video data and generate a score describing a detection.

In an embodiment, the device is further configured for analyzing the video data using the datasets and an object detection model trained to detect at least one object in the video data indicative of a potential hazard, the object detection model comprising a machine learning based model configured to receive the video data and generate annotated video data as an output.

In an embodiment, the detection information includes at least one of an antenna type, a gain, a polarization, an RFID tag type, an apparel type, an asset type, a number of times a specific RFID tag was detected, an RFID tag detection frequency, a distribution of RFID tags associated with a unique apparel identifier, a distribution of RFID tags associated with a unique asset identifier, a transceiver power level used to detect an RFID tag, and an RSS value measured by a transceiver during RFID tag detection.

In an embodiment, the score is one of a single numerical score; and a categorical score.

In an embodiment, an antenna of the device is located one of internal to the device; and external to the device.

In an embodiment, an antenna of the device is at least one of a directional single node antenna with linear polarization and integrated antenna controller; a directional dual node antenna with linear polarization and integrated antenna controller; a planar antenna element with circular polarization; and an omnidirectional vertical whip antenna with vertical polarization.

In an embodiment, the device if further configured for communicating data about the at least one object to the RFID antenna device.

In an embodiment, the object detection model is further trained to derive ranging information about the at least one object from the communicated data.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIGS. 1A and 1B are schematic diagrams of systems for object detection, according to an embodiment;

FIG. 1C is an alternative depiction of the system of FIG. 1A, according to an embodiment;

FIG. 2 is a flowchart of a method of object detection, according to an embodiment;

FIG. 3 is a schematic diagram of a device for object detection, according to an embodiment;

FIG. 4 is a schematic diagram of an example electronic device, according to an embodiment;

FIG. 5A is a series of images of antenna types for object detection, according to an embodiment;

FIG. 5B is a series of images of antenna beams corresponding to different antenna types of FIG. 5A;

FIGS. 6A and 6B is a diagram of example cable connections in an RFID scanning system; according to an embodiment; and

FIGS. 7A and 7B are detection ranges for different RFID tag types and RFID scanning system RF power levels, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

As used herein, the term “about” should be read as including variation from the nominal value, for example, a +/−10% variation from the nominal value. It is to be understood that such a variation is always included in a given value provided herein, whether or not it is specifically referred to.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be an embedded systems, a programmable logic controller, a mainframe computer, server, and personal computer, cloud-based program or system, laptop, personal data assistant, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present disclosure.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to safety equipment on machinery, and more particularly to systems, methods and devices for human and asset detection using radio frequency identification and artificial intelligence in machine-to-human and machine-to-asset collision avoidance applications.

Active detection systems, such as RFID detection systems, have proven to be one of the most reliable technologies to use for ground-worker, valued asset and hazard detection in construction, oil and gas, waste, forestry, mining, industrial, and other extreme environment applications. Workers entering a job site are required to wear RFID tag-equipped personal protective equipment (PPE), and valued assets and hazards are tagged with RFID markers so that they can be detected by the job site's mobile equipment-mounted RFID scanning antennas.

The main components of an RFID scanning system for machine-to-human and machine-to-asset collision avoidance applications are generally an antenna, a processing/computing component, a display, an external alarm, and a mounting bracket.

Housed in a rugged and sealed weatherproof enclosure, the beam-shaping antenna monitors the area around the vehicle. The antenna system is designed to detect associated safety apparel and uses a reliable wireless link to relay its information to a display unit located near the equipment operator. The system may also be able to capture and store data.

The rugged and compact display unit uses both a bright visual display (LEDs) and an audible alarm (adjustable volume) to alert the equipment operator when safety apparel is detected. The display unit is linked wirelessly to the antenna system and regular self-diagnostic checks ensure that the link to the antenna system is present and the system is functioning normally.

An external beeper alarm is an essential accessory, mounted on the outside of the vehicle (e.g., mobile equipment) to allow groundworkers in the vicinity to hear a staccato alert warning on the detection of a tagged worker in an area of interest (e.g., a danger zone).

Company-owned mobile equipment is usually outfitted with RFID scanning antennas at the original equipment manufacturer (OEM) factory or as an after-market product before the start of the job. Contractors who bid on the job and temporarily bring their own specific mobile equipment on-site to perform certain tasks are required to install RFID scanning antenna systems on their equipment and to ensure that their workers wear RFID tag-equipped PPE.

As such, RFID presence sensing for machine-to-human or machine-to-asset applications is typically limited to the identification of an RFID tag within the antenna's detection field. The detection field is created by the shape of the antenna radiation pattern which can be omnidirectional (360 degrees), or directional for focused area sensing. The resolution of detection is binary, with the RFID tag being either detected as present within the antenna field of view or not present at all.

Though extremely effective in reducing stuck-by accidents, RFID presence sensing in its current form does not provide effective ranging information through the use of a single antenna. A plurality of directional antennas can be used to provide overlapping detection fields, thereby allowing for a coarse means of angular presence detection around the machine, however, information identifying the proximal distance of the detected tag from the machine is still no more specific than the broad extent of the antenna field beyond the machine. What is required is a means for determining the proximal range of the RFID tag in the detection field as the machine approaches the tagged human or asset.

Like active worker detection systems, cameras and in-cab mounted camera video displays have also been utilized to reduce struck-by accidents by providing an enhanced view of blind spots and danger areas to an equipment operator.

Camera systems have generally been considered passive safety systems, being utilized effectively only when the equipment operator views the in-cab display, similar to mirrors. Though capable of showing an image of exactly what is in the equipment's blind spot, a camera system still requires the operator to observe the video display and identify the hazard while maneuvering the equipment, a task that is often difficult to do while simultaneously monitoring other indicators, controls, mirrors, and devices that require attention during such a procedure.

Artificial Intelligence (AI) algorithms have been developed to identify and alert via audible and visual means the presence and proximity of human-shaped objects captured in the camera's field of view. These AI cameras have been deployed on mobile equipment and have been demonstrated to be greater than 90% effective in the detection of human presence in struck-by accident mitigation.

While effective in adding an active warning feature to the camera view, AI camera-based proximity warning systems suffer from several drawbacks, including the inability to detect the presence of a ground worker in certain non-upright or blocked positions, as well as the inability to provide a clear image for effective AI processing when the camera lens becomes covered in dust, dirt, ice, and condensation.

Another shortcoming of AI cameras for human detection is that they cannot identify in real-time who is being detected, which is a critical component of worker training for stuck-by and near-miss mitigation in a health and safety program. AI cameras are also ineffective in detecting specific assets and hazards on the job site that also need protection from struck-by incidents, such as wellheads, gas cylinders, keep-out markers, or other items requiring protection.

Accordingly, techniques disclosed herein utilize AI technology to analyze the detection data from an RFID presence sensing system and combine data from said analysis with the imaging and detection information of an AI camera presence sensing system.

Advantageously, by utilizing an AI camera presence sensing system together with an RFID presence sensing system, the unique benefits of each of these technologies can be enhanced to reduce the likelihood of false negative detection, thereby creating a highly reliable system for human and asset detection for struck-by and near-miss mitigation.

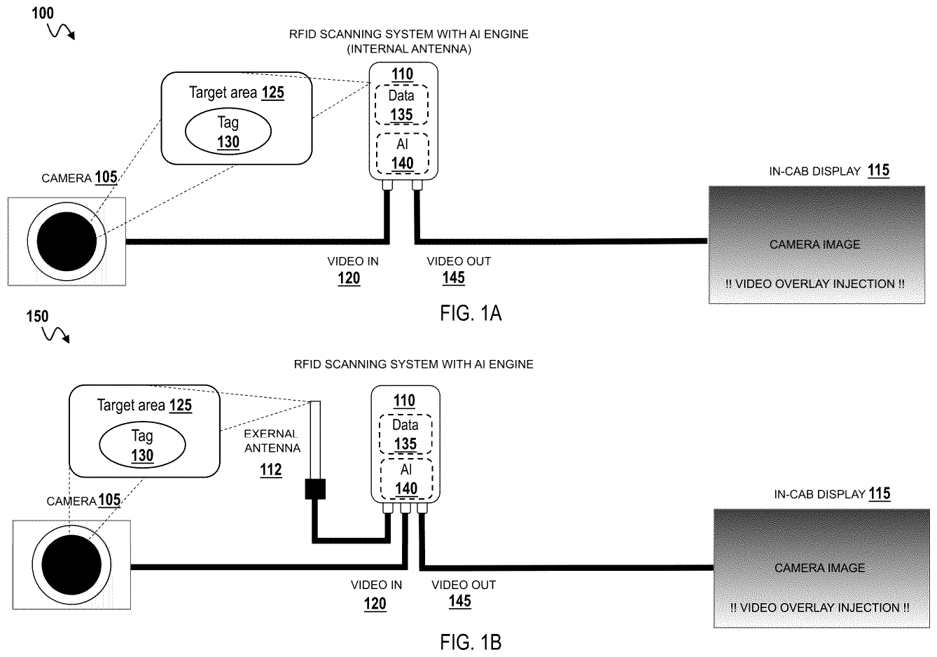

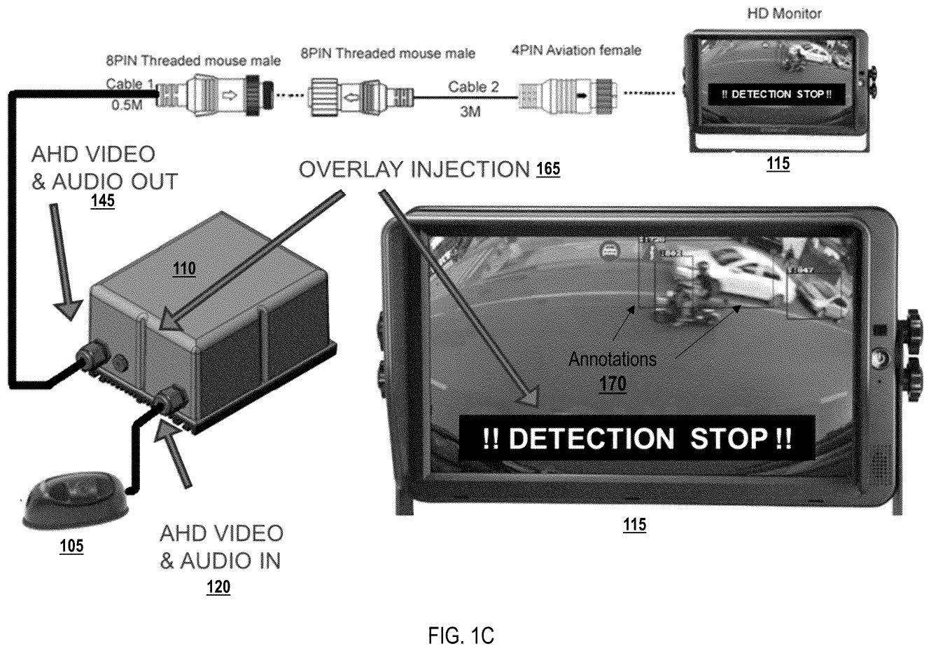

Referring now to FIG. 1A, shown therein is a schematic diagram of a system 100 for object detection, according to an embodiment of the present disclosure.

The system 100 includes a radio-frequency identification (RFID) antenna device 110.

The RFID antenna device 110 is configured for scanning a target area 125. The scanning may be for one or more RFID tags 130.

In various embodiments, the RFID tags 130 may be uniquely identified by a programmable and readable Tag ID consisting of, but not limited to, a serial number, a manufacturer ID, tag type, apparel/asset type, unique apparel/asset identifier (kit), and the tag position on the unique apparel/asset.

In various embodiments, RFID tags 130 may be integrated into personal protective equipment (PPE) to be worn by personnel.

Further, assets may be equipped with a plurality of RFID tags 130 that are mounted in varying orientations. These may be all of the same type, or they can also be a mix of different types that are either more or less sensitive to detection.

The RFID antenna device 110 is further configured for generating a dataset 135 based on the scanning, wherein the dataset 135 includes detection information for one or more RFID tags 130.

The collected tag read data is accumulated in real-time to be processed using an edge-based or cloud-based AI algorithm.

The RFID antenna device 110 is further configured for processing the dataset 135 using an analysis model 140 trained to analyze datasets, the analysis model 140 comprising a machine learning based radial distance model configured to receive the dataset 135 and generate a value describing a radial distance as an output.

The AI algorithm analyzes the multi-dimensional data set to determine the approximate radial distance that the tagged apparel or asset is from the specific antenna that detected the tag.

A plurality of antennas as fixed locations can then be used to triangulate the radial distance information to further determine the approximate angular location that the tagged apparel or asset is from the specific antenna that detected the tag.

The RFID antenna device 110 is further configured for providing the output to a user device 115.

In an embodiment, the system 100 includes an imaging device 105.

The imaging device 105 may be configured for capturing video data 120 of the target area 125.

The imaging device 105 may further be configured for providing the video data 120 to the RFID antenna device 110.

The imaging device 105 (e.g., a camera) may capture images of the desired view and feeds a video signal into the integrated antenna controller. The camera can be either a single camera or a plurality of cameras, with a single or stitched (360 degrees) view.

In an embodiment, the RFID antenna device 110 is further configured for analyzing the video data 120 using the dataset 135 and an object detection model trained to detect at least one object in the video data 120 indicative of a potential hazard, the object detection model comprising a machine learning based model configured to receive the video data 120 and generate annotated video data 145.

In an embodiment, the detection information includes at least one of an antenna type, a gain, a polarization, an RFID tag type, an apparel type, an asset type, a number of times a specific RFID tag was detected, an RFID tag detection frequency, a distribution of RFID tags associated with a unique apparel identifier, a distribution of RFID tags associated with a unique asset identifier, a transceiver power level used to detect an RFID tag, and an RSS value measured by a transceiver during RFID tag detection.

Other measurable parameters may exist that influence the ability of an RFID tag to be detected and the scope of this invention should not be limited to the influence of the parameters listed above.

In some embodiments, the RFID antenna device 110 with integrated antenna controller scans for RFID tags 130 to collect a detection data set in real-time. The AI engine in the RFID antenna device 110 processes the real-time detection data set from the detected RFID tags 130 and overlays/injects information from the RFID antenna device 110 onto the video data 120 to generate annotated video data as an output 145. This output is then displayed to the equipment operator on the user device 115 (e.g., a viewable monitor) along with the streamed video from the imaging device.

In various embodiments, the overlayed/injected information includes a warning symbol, the range of the detected tag 130, or information that was read from the RFID tag 130. An audible and visual warning alert may also be provided to the operator either on RFID tag 130 detection, on an AI camera image detection, or both.

In an embodiment, the imaging device 105 is further configured for identifying a target in the video data 120 using a detection model trained to detect targets, the detection model comprising a machine learning based target detection model configured to receive the video data 120 and generate a score describing a detection.

In an embodiment, the score is one of a single numerical score, and a categorical score.

In various embodiments, a greater score may correspond to a detection being of greater confidence.

For example, the score may quantify a level of detection out of 100. In some cases, scores may be divided into bands where numerical scores within a given band are categorized into the same category. Similarly, the score may include a binary determination, wherein a value of “1” corresponds to a detection, while a value of “0” corresponds to no detection.

In other examples, the score may include a categorical score. For example, in an embodiment, the score may be assigned from a fixed set of three or more possible categories with each corresponding to a level of detection (e.g., none, low, medium, or high). In some examples, a categorical score may be determined by converting a numerical score to a categorical score, wherein each category corresponds to a range of possible numerical score values.

In an embodiment, the location of an antenna of the RFID antenna device 110 is one of internal to RFID antenna device 110, and external to the RFID antenna device 110.

In FIG. 1B, the system 150 shown therein depicts an antenna 112 that is external to the RFID antenna device 110.

An antenna of the RFID antenna device 110 (e.g., antenna 112) may be a single antenna or a plurality of antennas. The antenna may be of different types, polarization, and gains to realize different shapes and ranges of the RFID tag 130 detection target area 125.

In an embodiment, an antenna of the RFID antenna device is at least one of a directional single node antenna with linear polarization and integrated antenna controller, a directional dual node antenna with linear polarization and integrated antenna controller, a planar antenna element with circular polarization, and an omnidirectional vertical whip antenna with vertical polarization.

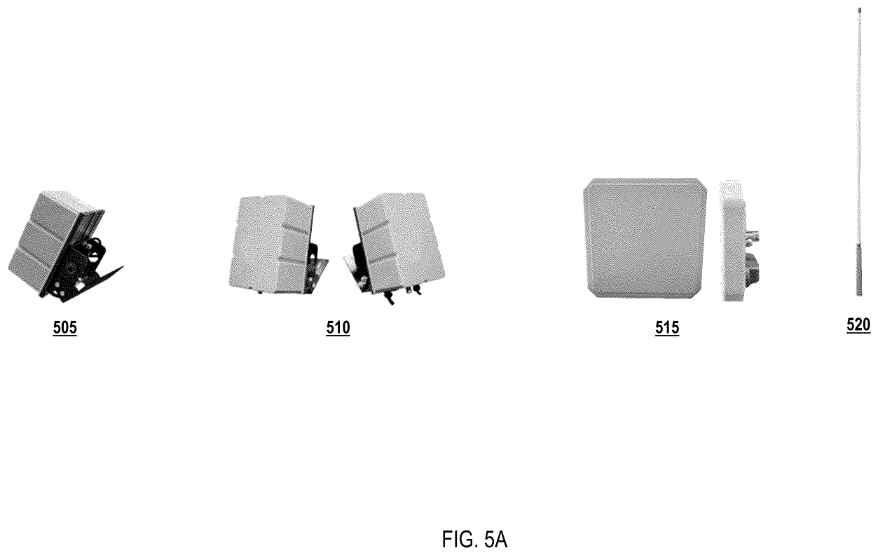

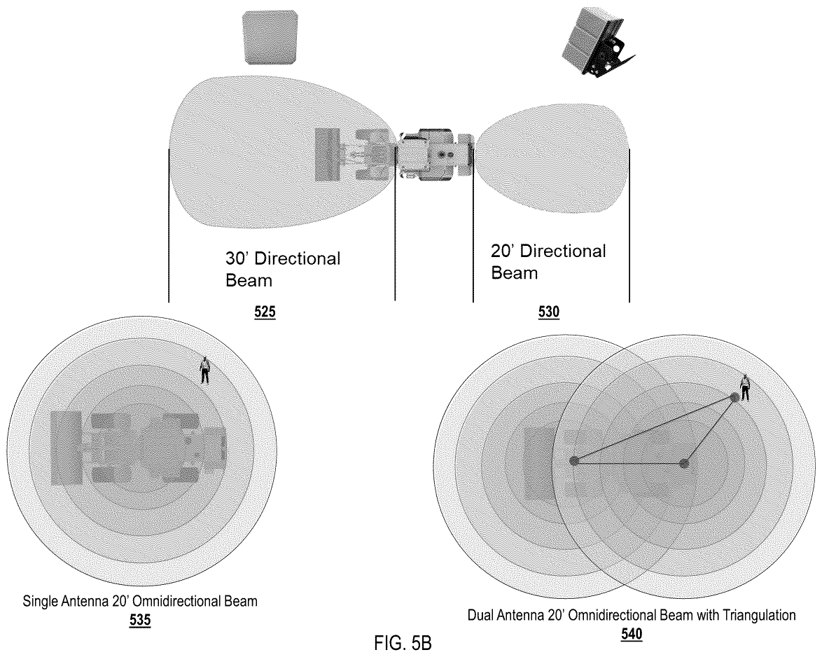

FIG. 5A depicts a direction single node antenna with linear polarization and integrated antenna controller 505, a directional dual node antenna with linear polarization and integrated antenna controller 510, a planar antenna element with circular polarization 515, and an omnidirectional vertical whip antenna with vertical polarization 520.

FIG. 5B depicts antenna beams corresponding to different antenna types of FIG. 5A. In FIG. 5B, beam 525 corresponds to a planar antenna element with circular polarization 515, beam 530 corresponds to a direction single node antenna with linear polarization and integrated antenna controller 505, beam 535 corresponds to an omnidirectional vertical whip antenna with vertical polarization 520, and beam 540 corresponds to dual antenna 520 omnidirectional beam with triangulation.

In an embodiment, the system further includes at least one of an RFID transceiver, and an RFID transponder for communicating data about the at least one object to the RFID antenna device.

In an embodiment, the object detection model is further trained to derive ranging information about the at least one object from the communicated data.

In various embodiments, the RFID transceiver, either internally integrated with, or externally connected to the RFID antenna device 110 continuously scans for RFID tags 130 within the detection field.

Referring now to FIG. 1C, shown therein is an alternative depiction of the system of FIG. 1A, according to an embodiment of the present disclosure.

In FIG. 1C, the output 145 is more clearly depicted, with a text overlay injection 165 (!! DETECTION STOP !!), and annotations 170.

Annotations 170 may indicate the distance between a detected object and the RFID antenna device 110.

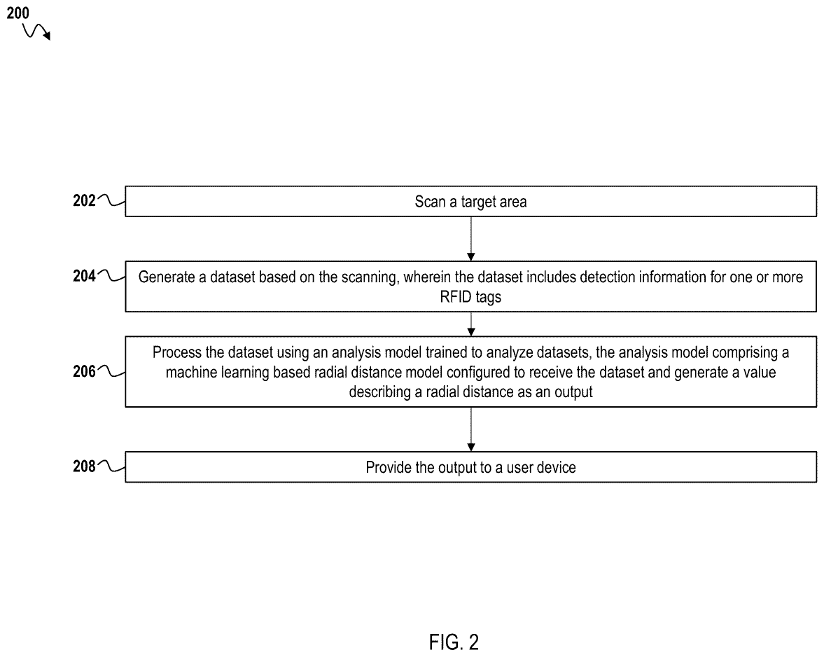

Referring now to FIG. 2, shown therein is a flowchart of a method 200 of object detection, according to an embodiment of the present disclosure.

The method 200 may be encoded as computer-executable instructions which, when executed by one or more processors, cause the computer to perform the method.

At 202, the method 200 includes scanning a target area. The scanning may be for one or more RFID tags.

At 204, the method 200 further includes generating a dataset based on the scanning, wherein the dataset includes detection information for one or more RFID tags.

At 206, the method 200 further includes processing the dataset using an analysis model trained to analyze datasets, the analysis model comprising a machine learning based radial distance model configured to receive the dataset and generate a value describing a radial distance as an output.

At 208, the method 200 further includes providing the output to a user device.

In an embodiment, the method 200 further includes capturing video data of the target area.

In an embodiment, capturing the video data further includes identifying a target in the video data using a detection model trained to detect targets, the detection model comprising a machine learning based target detection model configured to receive the video data and generate a score describing a detection.

In an embodiment, the score is one of a single numerical score, and a categorical score.

In an embodiment, the method 200 further includes analyzing the video data using the datasets and an object detection model trained to detect at least one object in the video data indicative of a potential hazard, the object detection model comprising a machine learning based model configured to receive the video data and generate annotated video data as an output.

In an embodiment, the detection information includes at least one of an antenna type, a gain, a polarization, an RFID tag type, an apparel type, an asset type, a number of times a specific RFID tag was detected, an RFID tag detection frequency, a distribution of RFID tags associated with a unique apparel identifier, a distribution of RFID tags associated with a unique asset identifier, a transceiver power level used to detect an RFID tag, and an RSS value measured by a transceiver during RFID tag detection.

In an embodiment, an antenna used for the scanning is located one of internal to an RFID antenna device, and external to an RFID antenna device.

In an embodiment, an antenna used for the scanning is at least one of a direction single node antenna with linear polarization and integrated antenna controller, a directional dual node antenna with linear polarization and integrated antenna controller, a planar antenna element with circular polarization, and an omnidirectional vertical whip antenna with vertical polarization.

FIG. 5A depicts a direction single node antenna with linear polarization and integrated antenna controller 505, a directional dual node antenna with linear polarization and integrated antenna controller 510, a planar antenna element with circular polarization 515, and an omnidirectional vertical whip antenna with vertical polarization 520.

FIG. 5B depicts antenna beams corresponding to different antenna types of FIG. 5A. In FIG. 5B, beam 525 corresponds to a planar antenna element with circular polarization 515, beam 530 corresponds to a direction single node antenna with linear polarization and integrated antenna controller 505, beam 535 corresponds to an omnidirectional vertical whip antenna with vertical polarization 520, and beam 540 corresponds to dual antenna omnidirectional beam with triangulation.

In an embodiment, the method further includes communicating data about the at least one object to an RFID antenna device.

In an embodiment, the object detection model is further trained to derive ranging information about the at least one object from the communicated data.

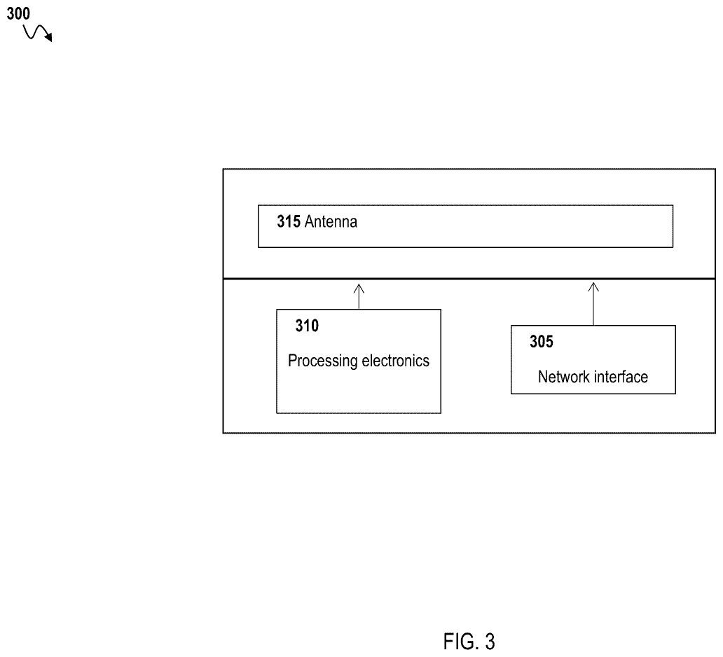

Referring now to FIG. 3, shown therein is a device 300 for object detection, according to an embodiment of the present disclosure.

In various embodiments, the apparatus 300 may be an RFID antenna device.

The device 300 includes a network interface 305 and processing electronics 310.

The processing electronics 310 may include a computer processer executing program instructions stored in memory, or other electronics components such as digital circuitry, including for example FPGAs and ASICs.

The network interface 305 may include an optical communication interface or radio communication interface, such as a transmitter and receiver, capable of, for example, sending and receiving messages.

The apparatus 300 further includes an antenna 315.

In an embodiment, the antenna 315 used for the scanning is at least one of a direction single node antenna with linear polarization and integrated antenna controller, a directional dual node antenna with linear polarization and integrated antenna controller, a planar antenna element with circular polarization, and an omnidirectional vertical whip antenna with vertical polarization.

In an embodiment, the antenna 315 is housed in a rugged and/or sealed weatherproof enclosure.

In an embodiment, the antenna 315 is a beam-shaping antenna.

In an embodiment, the antenna 315 scans a target area.

The device 300 may include several other functional components, each of which is partially or fully implemented using the underlying network interface 305 and processing electronics 310.

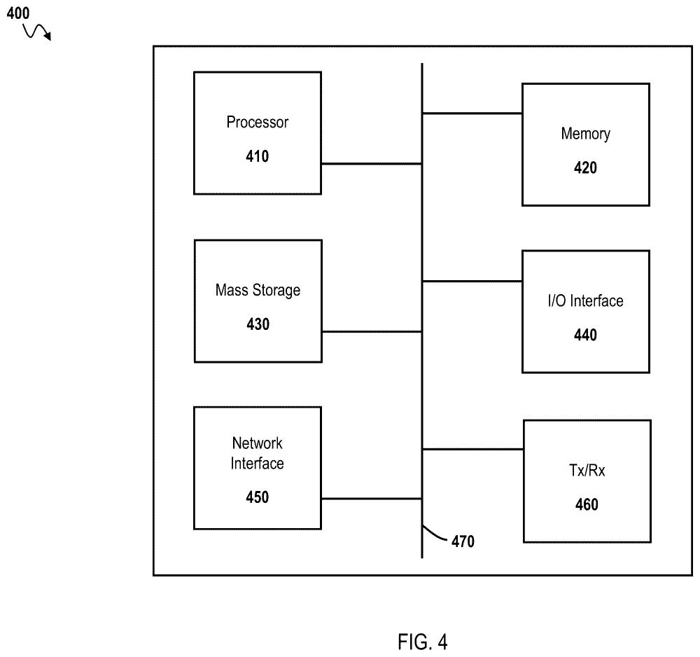

Referring now to FIG. 4, shown therein is a schematic diagram of an electronic device 400 that may perform any or all of operations of the above methods and features explicitly or implicitly described herein, according to different embodiments of the present disclosure. For example, a computer equipped with network function may be configured as electronic device 400. Furthermore, the electronic device 400 may be used to implement the device 300 of FIG. 3, for example.

As shown, the device includes a processor 410, such as a Central Processing Unit (CPU) or specialized processors such as a Graphics Processing Unit (GPU) or other such processor unit, memory 420, non-transitory mass storage 430, I/O interface 440, network interface 450, and a transceiver 460, all of which are communicatively coupled via bi-directional bus 470.

According to certain embodiments, any or all of the depicted elements may be utilized, or only a subset of the elements. Further, the device 400 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 420 may include any type of non-transitory memory such as static random access memory (SRAM), dynamic random access memory (DRAM), synchronous DRAM (SDRAM), read-only memory (ROM), any combination of such, or the like.

The mass storage element 430 may include any type of non-transitory storage device, such as a solid state drive, hard disk drive, a magnetic disk drive, an optical disk drive, USB drive, or any computer program product configured to store data and machine executable program code.

According to certain embodiments, the memory 420 or mass storage 430 may have recorded thereon statements and instructions executable by the processor 410 for performing any of the aforementioned method operations described above.

For example, the electronic device 400 may be configured for: scanning a target area; generating a dataset based on the scanning, wherein the dataset includes detection information for one or more RFID tags; processing the dataset using an analysis model trained to analyze datasets, the analysis model comprising a machine learning based radial distance model configured to receive the dataset and generate a value describing a radial distance as an output; and providing the output to a user device.

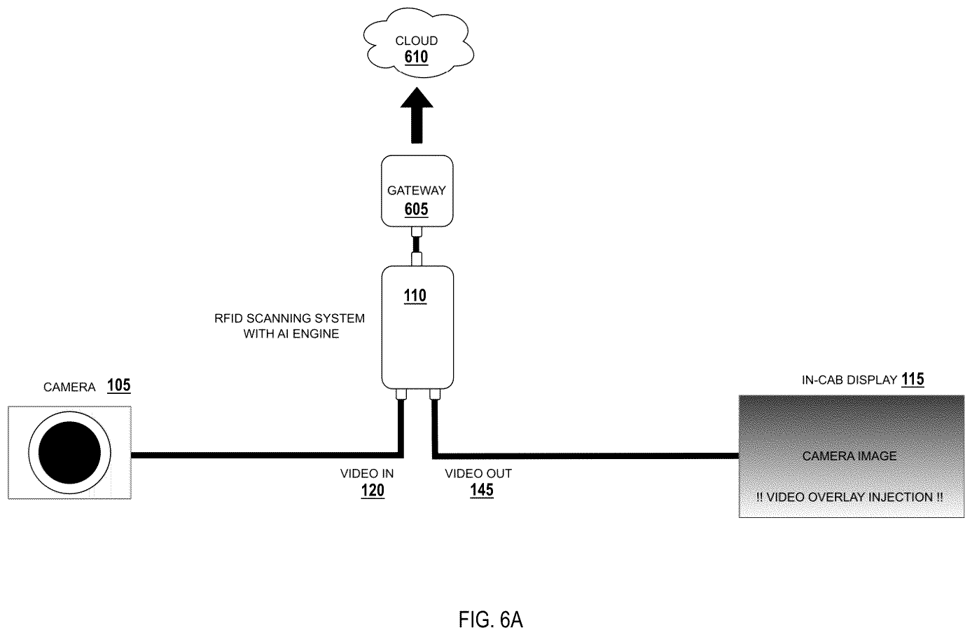

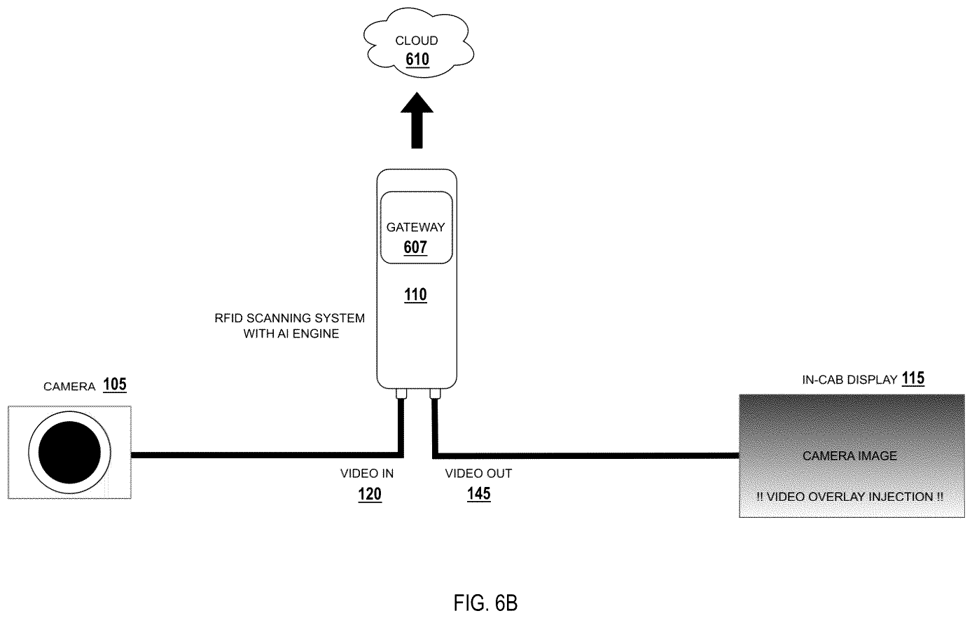

Referring now to FIG. 6A, shown therein is the system 100 of FIG. 1, further including an external gateway 605 and a cloud network 610.

The RFID antenna device 110 may connect via an external gateway 605 to the cloud network 610 and may communicate with various external devices via a wired connection using RS-485, RS-232, CAN, or other hardware communication interfaces. The gateway 605 may use cellular, WiFi, Bluetooth, or other means to connect to the cloud.

In an embodiment, a machine (e.g., a construction equipment) may be equipped with a plurality of systems 100 connected to and communication with each other and to the external gateway 605 to the cloud network 610.

Referring now to FIG. 6B, shown therein is the system 100 of FIG. 1, further including an internal gateway 607 and a cloud network 610.

The RFID antenna device 110 may be connected via an internal gateway 607 to the cloud 610 and may communicate wirelessly to external devices via cellular, WiFi, Bluetooth, or other means.

The RFID antenna device 110 records and transmits information such as the system status and the timestamped detection events. Stored and transmitted detection event information may include captured video images, detected Tag IDs, range of detected tags, and memory contents of the detected tags. In another embodiment, the transmitted information may include the full or partial real-time data set utilized for AI/ML processing.

According to another aspect of the present disclosure, techniques for real time detection dataset generation are provided.

A machine-mounted RFID antenna device is configured with a directional or omnidirectional (360-degree) detection field, depending on the type of antenna used. The antennas may also be designed to generate either circularly polarized, or linearly polarized, or non-polarized RF radiation patterns.

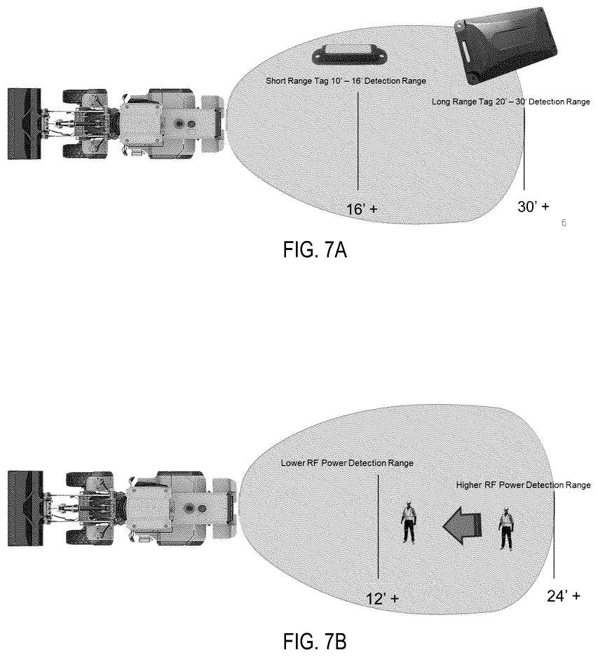

Referring now to FIGS. 7A and 7B, shown therein are differing tag ranges (FIG. 7A) and low-power vs. high-power RF detection ranges (FIG. 7B).

In various embodiments, antenna detection fields may be expanded and collapsed in real-time by setting the RFID transceiver to different power levels before each RFID tag read.

RFID tags detected at one power level, may not be detected at another power level, and the ability to detect the RFID tags is highly influenced by the type of tag, the orientation of the tag, and the polarization of the antenna's RF radiation field.

Generally, when scanning for a plurality of RFID tags within a detection field, tags read at high power levels will detect more tags at the same radial distance. Tags closer to the antenna are more likely to be detected than tags further away from the antenna. Tags with different planar orientations relative to the antenna will also be detected at different power levels. At the same power level, tags aligned with the radiated field will be detected more often than tags not aligned with the radiated field.

In various embodiments, each successful tag read by the RFID transceiver will also record a Received Signal Strength (RSS) value of the RF signal reflected back from the detected RFID tag.

The RSS value of the detected tag is highly influenced by a variety of factors including the tag's distance from the antenna, the orientation of the tag, the tag type, the power level used by the RFID transceiver during the tag read, and the polarization of the antenna's RF radiation field.

By modulating the power level over a period of successive tag reads, a data set can be collected that captures the unique influences of the detectability of the plurality of RFID tags integrated with the human-worn tagged apparel or tagged asset.

The detected tag data set is generated through continuous reads by the RFID transceiver in real-time. Detected Tag IDs and the associated RSS and power level used for the tag read are timestamped and continuously stored in either a table, database, or some other format in a stored memory location.

While the above description provides examples of one or more apparatuses, methods, or systems, it will be appreciated that other apparatuses, methods, or systems may be within the scope of the claims as interpreted by one of skill in the art.

Elements of each embodiment may be incorporated into other embodiments, for example, configurations discussed in relation to one embodiment, may be applied to other embodiments disclosed herein.

Further, it is evident that various modifications and combinations can be made without departing from the invention. The specification and drawings are, accordingly, to be regarded simply as an illustration of the invention as defined by the claims, and are contemplated to cover any and all modifications, variations, combinations or equivalents that fall within the scope of the present disclosure.

1. A system for object detection, the system comprising:
a radio-frequency identification (RFID) antenna device configured for:
scanning a target area;
generating a dataset based on the scanning, wherein the dataset includes detection information for one or more RFID tags;
processing the dataset using an analysis model trained to analyze datasets, the analysis model comprising a machine learning based radial distance model configured to receive the dataset and generate a value describing a radial distance as an output; and
providing the output to a user device.

2. The system of claim 1, further comprising an imaging device configured for: capturing video data of the target area; and providing the video data to the RFID antenna device.

3. The system of claim 2, wherein the imaging device is further configured for identifying a target in the video data using a detection model trained to detect targets, the detection model comprising a machine learning based target detection model configured to receive the video data and generate a score describing a detection.

4. The system of claim 2, wherein the RFID antenna device is further configured for analyzing the video data using the datasets and an object detection model trained to detect at least one object in the video data indicative of a potential hazard, the object detection model comprising a machine learning based model configured to receive the video data and generate annotated video data as an output.

5. The system of claim 1, wherein the detection information includes at least one of: an antenna type, a gain, a polarization, an RFID tag type, an apparel type, an asset type, a number of times a specific RFID tag was detected, an RFID tag detection frequency, a distribution of RFID tags associated with a unique apparel identifier, a distribution of RFID tags associated with a unique asset identifier, a transceiver power level used to detect an RFID tag, and an RSS value measured by a transceiver during RFID tag detection.

6. The system of claim 3, wherein the score is one of: a single numerical score; and a categorical score.

7. The system of claim 1, wherein an antenna of the RFID antenna device is located one of: internal to RFID antenna device; and external to the RFID antenna device.

8. The system of claim 1, wherein an antenna of the RFID antenna device is at least one of: a directional single node antenna with linear polarization and integrated antenna controller; a directional dual node antenna with linear polarization and integrated antenna controller; a planar antenna element with circular polarization; and an omnidirectional vertical whip antenna with vertical polarization.

9. The system of claim 1, further comprising at least one of: an RFID transceiver; and an RFID transponder for communicating data about the at least one object to the RFID antenna device.

10. The system of claim 9, wherein the object detection model is further trained to derive ranging information about the at least one object from the communicated data.

11. A method of object detection, the method comprising executing via a computer system comprising at least one processor:
scanning a target area;
generating a dataset based on the scanning, wherein the dataset includes detection information for one or more RFID tags;
processing the dataset using an analysis model trained to analyze datasets, the analysis model comprising a machine learning based radial distance model configured to receive the dataset and generate a value describing a radial distance as an output; and
providing the output to a user device.

12. The method of claim 10, further including capturing video data of the target area.

13. The method of claim 12, wherein capturing the video data further includes identifying a target in the video data using a detection model trained to detect targets, the detection model comprising a machine learning based target detection model configured to receive the video data and generate a score describing a detection.

14. The method of claim 12, further comprising analyzing the video data using the datasets and an object detection model trained to detect at least one object in the video data indicative of a potential hazard, the object detection model comprising a machine learning based model configured to receive the video data and generate annotated video data as an output.

15. The method of claim 11, wherein the detection information includes at least one of: an antenna type, a gain, a polarization, an RFID tag type, an apparel type, an asset type, a number of times a specific RFID tag was detected, an RFID tag detection frequency, a distribution of RFID tags associated with a unique apparel identifier, a distribution of RFID tags associated with a unique asset identifier, a transceiver power level used to detect an RFID tag, and an RSS value measured by a transceiver during RFID tag detection.

16. The method of claim 13, wherein the score is one of: a single numerical score; and a categorical score.

17. The method of claim 11, wherein an antenna used for the scanning is located one of: internal to an RFID antenna device; and external to an RFID antenna device.

18. The method of claim 11, wherein an antenna used for the scanning is at least one of: a direction single node antenna with linear polarization and integrated antenna controller; a directional dual node antenna with linear polarization and integrated antenna controller; a planar antenna element with circular polarization; and an omnidirectional vertical whip antenna with vertical polarization.

19. The method of claim 11, further including communicating data about the at least one object to an RFID antenna device.

20. A device for object detection, the device comprising:
a network interface;
a processor; and
a non-transitory computer readable memory having stored thereon instructions that, when executed by the processor, configure the device for:
scanning a target area;
generating a dataset based on the scanning, wherein the dataset includes detection information for one or more RFID tags;
processing the dataset using an analysis model trained to analyze datasets, the analysis model comprising a machine learning based radial distance model configured to receive the dataset and generate a value describing a radial distance as an output; and
providing the output to a user device.
